(19) United States
(12) Patent Application Publication
(10) Pub. No.: US 2026/0280188 A1
(43) Pub. Date: Sep. 17, 2026

(54) FLOATING POWER CONNECTOR

(71) Applicant: FCI USA LLC, Etters, PA (US)

(72) Inventors: Chun Hsiang Fu, Taoyuan City (TW); Yu-An Chen, Taoyuan City (TW); Yan-Zhu Chou, Taoyuan City (TW)

(73) Assignee: FCI USA LLC, Etters, PA (US)

(21) Appl. No.: 19/663,862

(22) Filed: Apr. 30, 2026

Related U.S. Application Data
(60) Provisional application No. 63/798,358, filed on May 1, 2025.

(51) Int. Cl. H01R 13/631; H01R 25/14; H01R 43/26

(52) U.S. Cl. CPC H01R 13/6315; H01R 25/142; H01R 43/26

(57) ABSTRACT

Power connectors for connecting to a power source are described. The power connector has features by which it may be locked within an opening of a panel while floating to enable alignment with a power source. Locking features may engage automatically by inserting and sliding the connector within a panel opening. The connector may be released from the panel by operation of a depressible tab, which may be accessible from a front of the power connector. The depressible tab may have an unbiased state in which it blocks the power connector from sliding into a position from which it can be removed from the panel opening and a recessed state in which the power connector may slide into a position from which it may be removed from the panel opening.

### BACKGROUND

### Field

The present disclosure relates generally to electrical connectors for electrically connecting to power sources and more specifically to power connectors for mounting to a panel with float.

### Related Art

Floating connectors are sometimes used to connect to power sources, such as busbars. The connector connects on one side to the power source and connects on its other side to one or more electronic components to which the power is to be distributed. One example is a connector connecting to a busbar in a rack-mounted system. The busbar may serve as a power source for rack-mounted electronics. The power connector has on one side a mating interface for connecting to the busbar and on the other side connect to cables, which in turn connect to components inside a rack-mounted electronic assembly.

The connector may be mounted in an opening in a panel of the electronic assembly and may “float” from side to side to align with the busbar.

### BRIEF SUMMARY

According to an aspect of the technology, a floating power connector is provided for connecting a power source to a plurality of cables. The floating power connector comprises: a housing having a mounting surface with a recess; a mating interface protruding from the mounting surface and having a plurality of electrical contacts configured to couple to the power source; and a depressible tab coupled with the housing of the floating power connector and having a protruding portion that protrudes beyond the mounting surface when unbiased and that sits flush with or is recessed from the mounting surface when pressed into the recess in the mounting surface.

According to an aspect of the technology, a floating power connector is configured to connect to a power source. The floating power connector comprises: a housing; a self-alignment mechanism configured to align the floating power connector with the power source; one or more terminals configured to couple to a cable; and a depressible tab configured to mechanically restrict the floating power connector from moving into an insertion position within an opening in a panel.

According to an aspect of the technology, a method is provided for removing a floating power connector from an opening in a panel in which the floating power connector is disposed. The method comprises: pressing a depressible tab of the floating power connector until a protruding portion of the depressible tab is flush with or recessed from a mounting surface of the floating power connector; sliding the floating power connector parallel to a plane of the mounting surface to a position in which a retention feature of the floating power connector is aligned with a complementary feature of the panel; and while the retention feature of the floating power connector is aligned with the complementary feature of the panel, moving the floating power connector in a direction substantially perpendicular to the plane of the mounting surface.

According to an aspect of the technology, a method is provided for inserting a floating power connector into an opening in a panel to which the floating power connector is to be mounted. The method comprises: aligning a retention feature of the floating power connector with a complementary feature of the panel; pressing the floating power connector against a first side of the panel to depress a depressible tab of the floating power connector into a recess in the floating power connector; and sliding the floating power connector in a direction parallel to the first side of the panel until the depressible tab returns to an unbiased state out of the recess in the floating power connector.

### BRIEF DESCRIPTION OF DRAWINGS

Various aspects and embodiments of the technology will be described with reference to the following figures. It should be appreciated that the figures are not necessarily drawn to scale. Items appearing in multiple figures are indicated by the same reference number in all the figures in which they appear.

FIG. 1A illustrates a front perspective view of a floating power connector for connecting a power source to a plurality of cables according to a non-limiting embodiment.

FIG. 1B illustrates a rear upper perspective view of the floating power connector of FIG. 1A.

FIG. 1C illustrates a rear lower perspective of the floating power connector of FIGS. 1A and 1B.

FIG. 1D illustrates a close-up front side perspective view of the floating power connector of FIG. 1A.

FIG. 1E illustrates a close-up front view of the depressible tab of the floating power connector of FIG. 1A.

FIG. 1F illustrates a close-up side view of the depressible tab of the floating power connector of FIG. 1A.

FIG. 1G illustrates a view of the floating power connector of FIG. 1A with the connector housing removed.

FIGS. 2A-2D show a sequence of steps to lock the floating power connector of FIGS. 1A-1F in an opening of a mounting component.

FIG. 3 is a flowchart of a process for inserting a floating power connector into a mounting component according to an embodiment.

FIGS. 4A-4C show a sequence of steps to remove the floating power connector from its mounted position in a mounting component.

FIG. 5 is a flowchart of a process for removing a floating power connector from a mounting component according to a non-limiting embodiment.

FIGS. 6A-6B illustrate a non-limiting example of components to which the power connectors of the types described herein may be connected.

FIG. 7 illustrates a top view of the complete floating power connector with cables and shows the amount of float provided.

### DETAILED DESCRIPTION

Aspects of the present technology provide floating power connectors having a robust mechanical locking mechanism that is simple to use and cost effective to manufacture and/or use. Alternatively, or additionally, the locking mechanism may occupy little or no space on the inner side of a panel to which the connector is mounted. Further, the locking mechanism may be actuated with little or no clearance on the inner side of the panel. Less space required on the inner side of the panel to install and/or actuate the power connector may be advantageous to manufacturers of electronic assemblies powered via the connector, as space not required to install or operate the power connector may be used to provide enhanced features or may enable manufacture of the assembly at reduced cost. As a specific example, the space around the power connector may be used for more or larger lugs and/or cables, thereby increasing the power handling capacity of the connector.

In some examples, the floating power connector may be configured to connect on one side to a power source, an example of which is one or more busbars, and to power distribution components, an example of which is one or more cables, on an opposing side. The floating power connector may have a housing configured for mounting within an opening of a mounting structure, an example of which is a panel of an electronic component within an electronics rack or cabinet.

The floating power connector may be shaped for insertion into or removal from the opening in an insertion position. As a specific example, the perimeter of the opening may include one or more notches and the housing of the power connector may include one or more retention features, an example of which is a protrusion. When in the insertion position, the retention features may align with the complementary features of the panel opening-such as notches in the panel-such that the power connector may be inserted into the opening. Once slid transversely from the insertion position, the retention features (e.g., protrusions) will no longer align with the complementary features (e.g., notches) of the panel and will therefore block the connector from being withdrawn from the opening. A locking mechanism may interfere with the power connector moving back into the insertion position once slid away from the insertion position, thereby locking the power connector within the opening.

The locking mechanism may, in some examples, be implemented with a depressible tab which is configured to lock and unlock the floating power connector within the opening. The depressible tab may be depressed into a recess in the floating power connector when the floating power connector is being inserted into the opening of the panel or other mounting component, and to snap back to its original position to lock the floating power connector in the opening. Removal of the floating power connector from the mounting component (e.g., panel) may be achieved by depressing the depressible tab into its recess and sliding the floating power connector back to the insertion position where it can be withdrawn from the mounting component (e.g., panel). In this manner, simple installation and removal of the floating power connector may be achieved.

In some examples, the depressible tab of the floating power connector is positioned on a mounting surface of the floating power connector and accessible from a front side of the floating power connector. A user may access the depressible tab from the front side of the floating power connector and may press the depressible tab back while sliding the floating power connector transversely into its insertion position.

In some examples, the depressible tab may be cantilevered, having one end fixed to the mounting surface of the floating power connector and another end free to move forward and back. The free end of the depressible tab may move in a direction perpendicular to the direction in which the floating power connector is slid into and out of the panel opening. In this manner, the depressible tab may lock the floating power connector in the opening.

The depressible tab may be coupled to the connector housing. In some examples, the depressible tab may be integrally formed with the connector housing. As a specific example, the connector housing may be molded of a thermoplastic material and the depressible tab may be formed in the same molding operation.

The aspects and embodiments described above, as well as additional aspects and embodiments, are described further below. These aspects and/or embodiments may be used individually, all together, or in any combination of two or more, as the application is not limited in this respect.

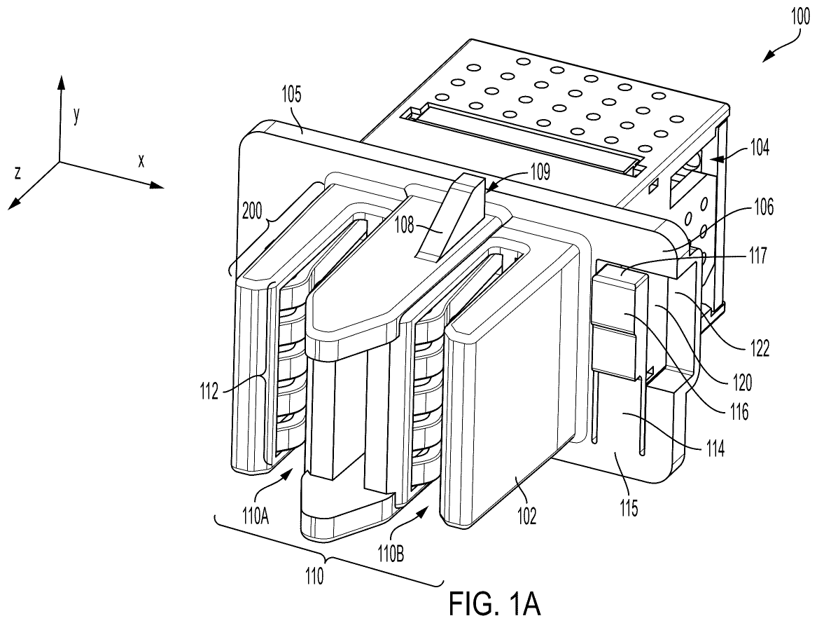

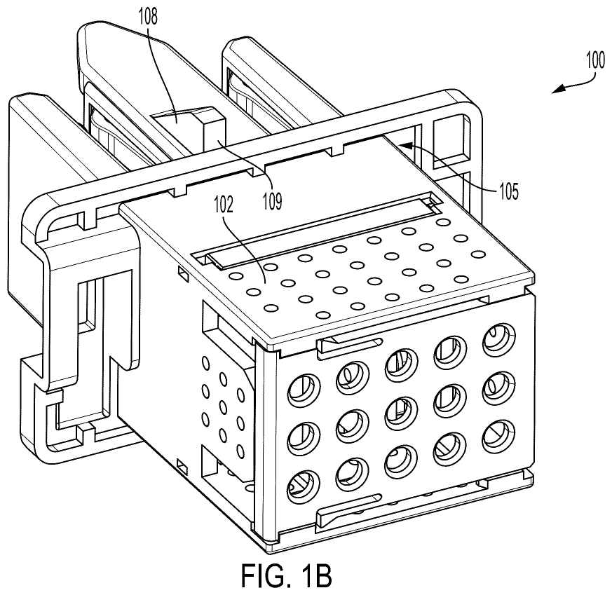

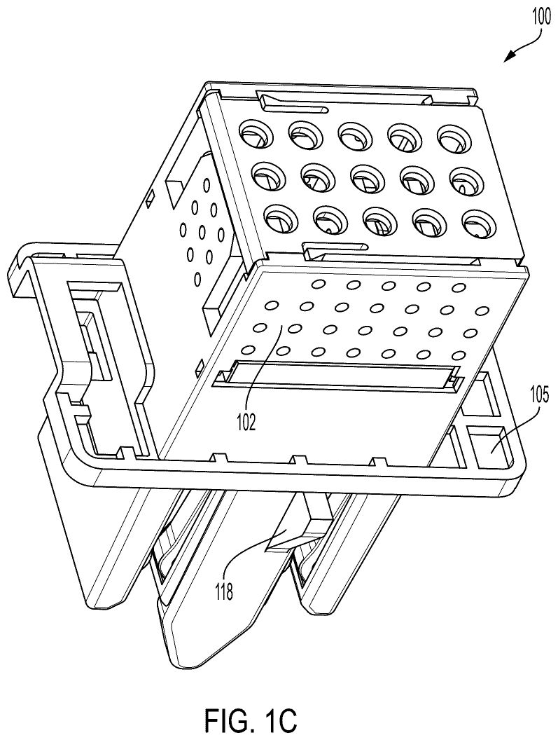

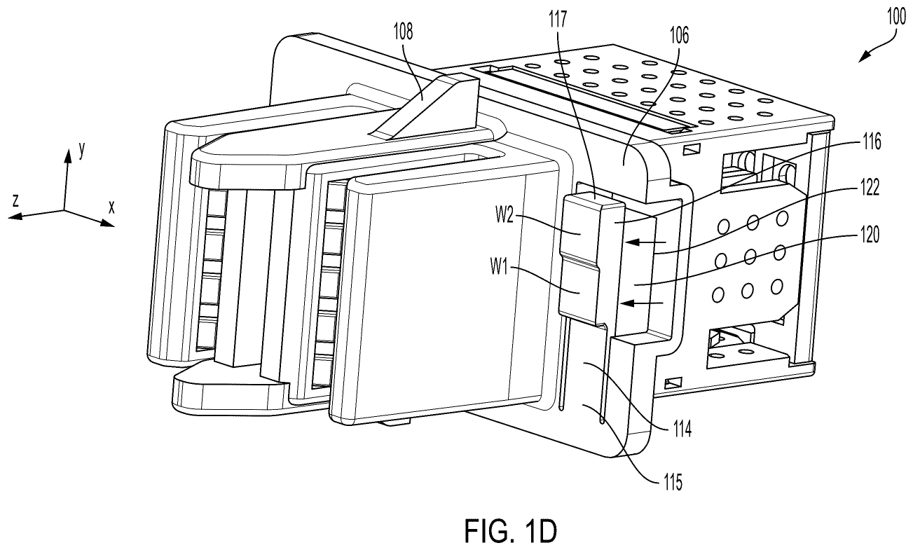

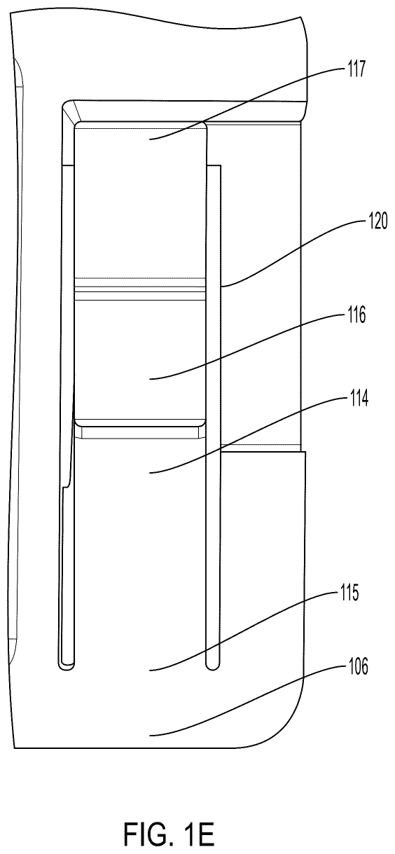

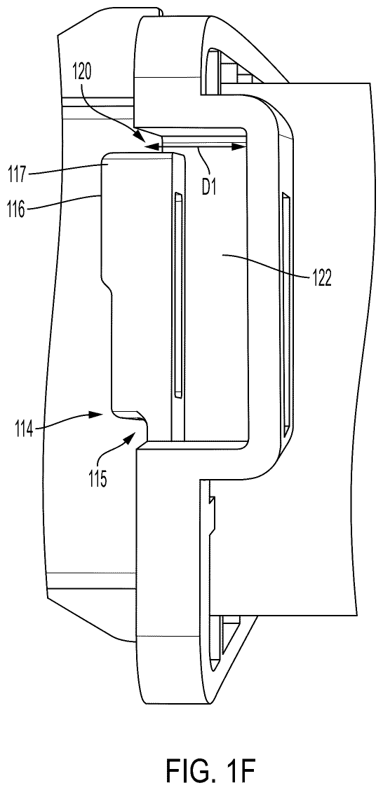

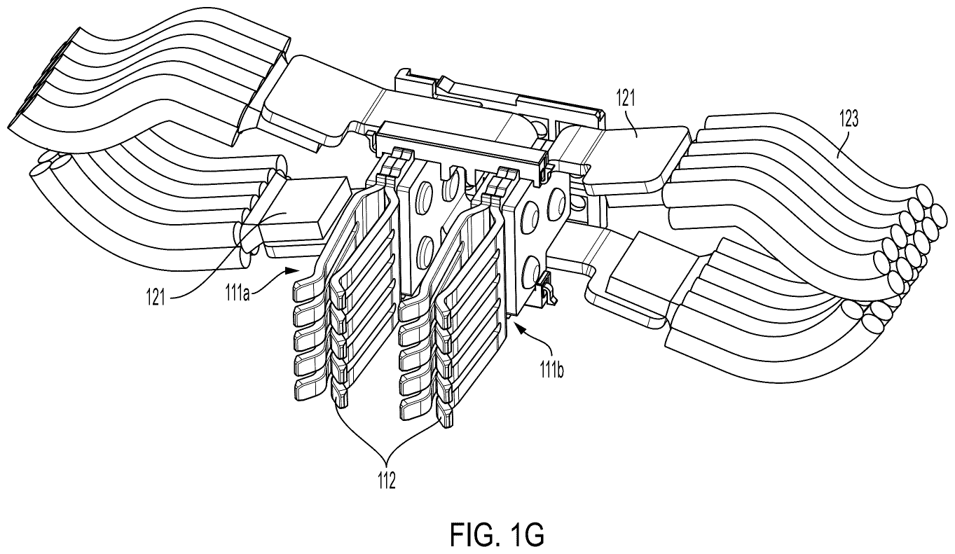

As described above, aspects of the present technology provide a floating power connector configured to connect to a power source, exemplified in the following description by two busbars, and to power distribution features, exemplified in the following description by two sets of cables. FIG. 1A illustrates a front perspective view of a floating power connector 100 for connecting two busbars to a plurality of cables according to a non-limiting example. The floating power connector 100 includes a connector housing 102 with ports 104 for receiving lugs (not shown) which can be connected to cables (not shown), a flange 105, a mounting surface 106, a retention feature 108, a self-alignment mechanism 110 with at least one row of electrical contacts 112, and a depressible tab 114 with a protruding portion 116.

The connector housing 102 may have a suitable shape for accommodating terminals that transfer power from the power source (not shown) to cables, which in the illustrated embodiment means from the electrical contacts 112 to the ports 104. For example, as shown, the connector housing 102 includes slots 110A and 110B, each of which is sized to receive a busbar. Electrical contacts 112, which in this example form the distal ends of terminals within housing 102, are exposed within the slots 110A and 110B such that when connector 100 is pressed into engagement with the busbars, the busbars with enter slots 110A and 110B and make contact with the terminals. In the example of FIG. 1A, slots 110A and 110B and their associated contacts 112 form a mating interface 200 for connector 100. An example of the terminals is illustrated in FIG. 1G, which provides a view of the floating power connector 100 with the connector housing 102 removed. This view illustrates the terminals 111a and 111b which terminate with lugs 121. The lugs 121 are connected to cables 123. Thus, it can be seen that the terminals 111a and 111b are configured to transfer power from a power source which contacts the electrical contacts 112 to the cables 123 via lugs 121 in this example.

Referring again to FIG. 1A, the connector housing 102 may contain a plurality of openings facilitating heat dissipation to avoid overheating of the floating power connector 100. In the example shown, the connector housing 102 includes a plurality of circular holes on the top, bottom, and back sides though which heat may be dissipated. Other shapes and positioning of such openings may be used in alternative embodiments.

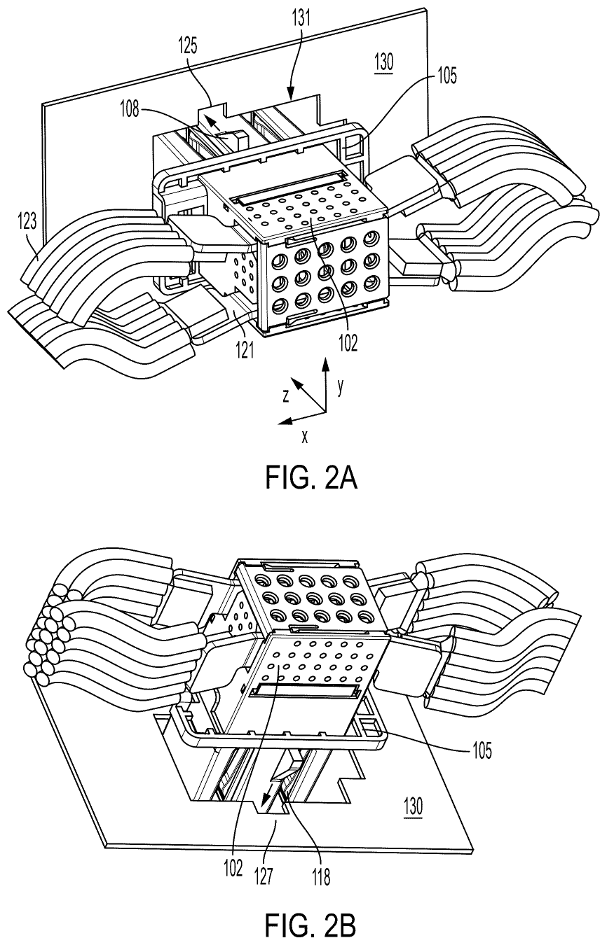

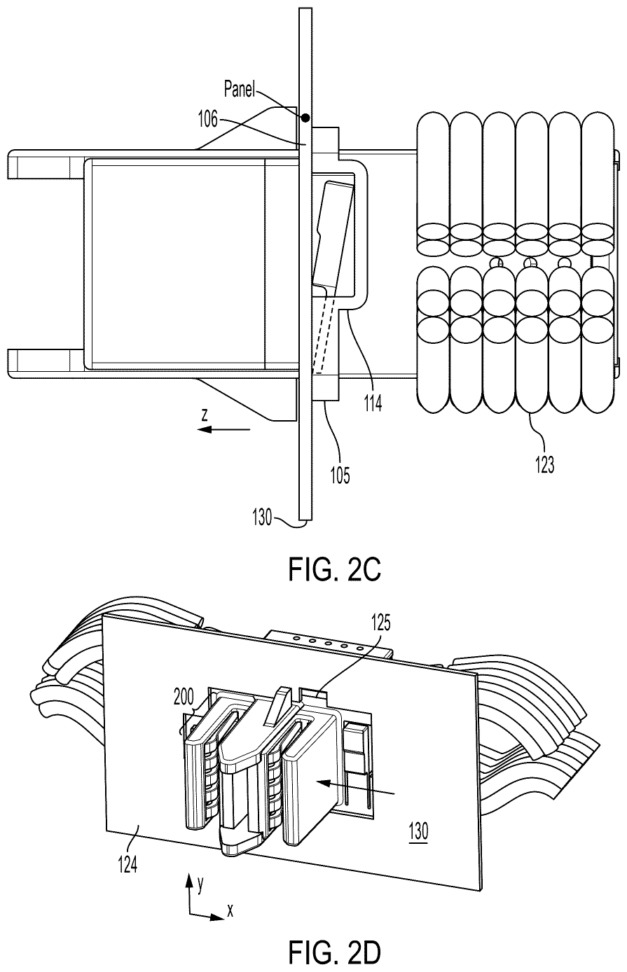

The connector housing 102 also may have one or more ports 104 through which electrical connections to cables may be formed. For example, the ports 104 may be configured to expose lugs 121 (FIGS. 1G and 2A) attached to the terminals 111a and 111b (FIG. 1G) of the connector such that the lugs 121 may be connected to a plurality of cables (e.g., cables 123), such as via welding. An example of such lugs and cables is illustrated in FIG. 1G and further in FIGS. 2A-2D and described further below. Any suitable number of such ports may be provided in the connector housing 102, and they may be positioned at any suitable location(s) of the connector housing 102.

The connector housing 102 may be made of any suitable material, as the specific material(s) used are not limiting of the various aspects of the present technology. For example, the connector housing 102 may be made of an electrically insulating material, allowing for safe handling and operation. In some embodiments, the connector housing 102 may be made of plastic.

The floating power connector 100 includes a flange 105. In the illustrated example, the flange 105 is integrally formed with the connector housing 102. The floating power connector 100 may be mounted to or within various systems and components, such as against a panel of an electronic assembly, said panel being one example of a mounting component. The flange 105 provides a structure for mounting the floating power connector 100 to such components. An example of such mounting is illustrated in FIGS. 2A-2D and described further below. Referring again to FIG. 1A, the flange 105 may have a suitable shape and size for mounting the floating power connector 100. For example, as shown, the flange 105 extends outwardly in multiple directions, including the x-direction and y-direction in FIG. 1A, relative to the rest of the connector housing 102. In the illustrated example, the flange 105 is substantially rectangular with rounded corners, but other shapes are possible. As illustrated in FIG. 2D, described below, the flange may be sized to couple to or interface with a panel or other component to which the floating power connector 100 is mounted.

As shown, for example, in FIG. 2A the flange may have an area larger than the area of a panel opening 131 into which connector 100 is to be inserted such that, upon insertion of the front of the connector into the opening from the inner side of the panel, connector 100 may be blocked from moving through the opening once flange 105 engages the panel. The mating interface 200 may extend forward (i.e. in the direction indicated as z in FIG. 1A) of flange 105, such that when flange 105 engages the panel, the mating interface 200 is exposed on the outer side of the panel. In this state, lugs 121 may be on the inner side of the panel.

The flange 105 includes the mounting surface 106 which is a surface of the flange 105 and may contact the panel or other component to which the floating power connector 100 is mounted. Like the flange 105, the mounting surface 106 may have a suitable shape, for example being substantially rectangular with rounded corners as illustrated. The mounting surface 106 may be substantially flat to facilitate good mechanical contact with a component to which the floating power connector 100 is mounted. As shown, the mounting surface 106 may include an opening 120 and a recess 122 of sufficient dimension to accommodate the depressible tab 114, as illustrated in FIGS. 1D-1F and described further below.

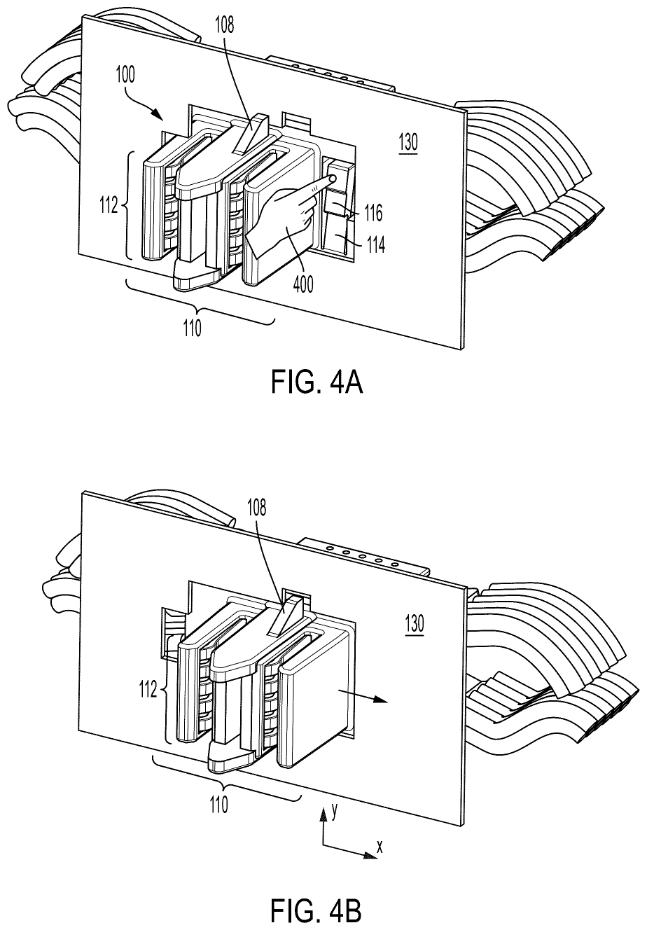

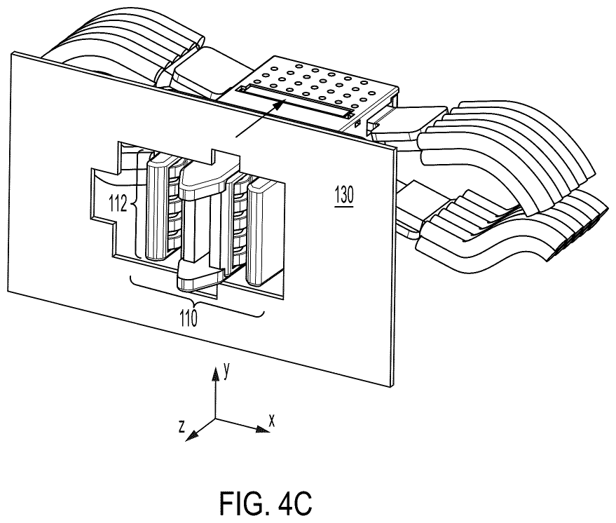

The depressible tab 114 may be used to prevent the floating power connector 100 from returning to its insertion position after being inserted into a panel or other mounting component, thereby locking the power connector within the opening of the panel while still allowing the floating power connector to float within the opening. The depressible tab 114 may be further used to release the floating power connector 100 from its mounted state by allowing the floating power connector 100 to be slid to its insertion position for removal from the opening of a panel. An example of such locking and release functionality is illustrated in FIGS. 2A-2D and 4A-4C and described further below. Referring still to FIG. 1A, the depressible tab 114 may be rectangular in shape, although other shapes are also possible. The depressible tab 114 may be cantilevered, having a first fixed end 115 that is fixed to the mounting surface 106 of the floating power connector 100, and a second free end 117 that can move in and out-of-plane from the mounting surface 106 (in the z-direction in FIG. 1A). The depressible tab 114 may have a protruding portion 116 that serves to prevent the floating power connector 100 from returning to its insertion position when the floating power connector 100 is in its mounted position, while still allowing the floating power connector 100 to float within the opening to accommodate misalignment between the floating power connector and the power source. The protruding portion 116 may have multiple segments of different widths W1 and W2 in some embodiments, as illustrated in FIG. 1D, but in alternative embodiments may have more or fewer widths. The protruding portion 116 of the depressible tab 114 may be pressed into the recess 122 in the flange 105 so that the protruding portion 116 no longer blocks the floating power connector 100 from sliding back to its insertion position, for example by sliding sufficiently far in the x-direction to align the complementary features of the floating power connector and the opening of the panel.

Referring to FIG. 1A, mating interface 200 includes a self-alignment mechanism 110, which may be integrally formed with the mounting surface 106. As shown, mating interface 200 has two slots, 110A and 110B, each lined on at least one side with contacts 112 of a terminal used to connect to a power source, such as a busbar. The electrical contacts 112 may be spring fingers in some embodiments. Housing walls may support and provide an insulative surround for the electrical contacts 112. For example, the mating interface 200 may comprise walls, separated to define slots 110A and 110B. In the illustrated example, each slot has contacts 112 of a terminal on both sides. In that example, there are five electrical contacts 112 aligned in a row on one side of the slot. In the illustrated example, there are contacts on each side of each slot, such that there are another five electrical contacts 112 adjacent a wall on the opposite side of the slot such that they can receive a busbar in the slot between the contacts. In the illustrated example, there are two slots with two sets of electrical contacts, enabling floating power connector 100 to make connection to two busbars. The plurality of electrical contacts 112 may be made of metal or another conductive material.

Some or all of the walls of the mating interface 200 may be tapered at their forward ends to aid in alignment of the slots 110A and 110B with busbars. If, for example, floating power connector 100 is misaligned with the busbars, the busbars may ride along the tapered walls as connector 100 and the busbars are pressed together. That riding motion may generate a camming force that urges floating power connector 100 in the direction labeled x in FIG. 1A. When floating power connector 100 is mounted in a panel with float, that force may move floating power connector 100 such that slots 110A and 110B are positioned to receive the busbars, enabling mating of floating power connector 100 to the busbars. This self-alignment mechanism provides for a tolerance in aligning the floating power connector 100 with the power source. For example, an alignment tolerance of millimeters or centimeters may be achieved in some embodiments.

The retention feature 108 may be integrally formed with the connector housing 102. The retention feature 108 may function in connection with the flange 105 to hold the floating power connector 100 to a panel or other electronic component. For example, the panel (or other mounting component) may fit between the mounting surface 106 and the retention feature 108 to restrain movement of the floating power connector in the z-direction (perpendicular to the plane of the flange 105). An example of such a configuration is illustrated in FIG. 2D and described further below. Referring again to FIG. 1A, the retention feature 108 may have any suitable shape and size for performing such a function. The retention feature 108 may provide an opposing surface 109 that opposes the mounting surface 106, so the panel or other mounting component may fit between them. In the illustrated embodiment, the retention feature 108 is a fin that has a right angle triangle shape. The retention feature 108 may serve as a stop.

FIG. 1B illustrates a rear upper perspective view of the floating power connector 100 of FIG. 1A. Many of the illustrated components have been described in connection with FIG. 1A, and so no further explanation of such components is provided with respect to FIG. 1B.

FIG. 1C illustrates a rear lower perspective of the floating power connector 100 of FIGS. 1A and 1B. As shown in FIG. 1C, the floating power connector 100 may include a second retention feature 118 on the bottom of the floating power connector 100. The second retention feature 118 may perform the same function described above in connection with the retention feature 108 and may have substantially the same shape as retention feature 108. However, not all embodiments are limited to having two identical retention features like those illustrated. In some embodiments, the retention features may differ in size and/or shape. In some embodiments, retention features other than protrusions may be provided.

FIG. 1D illustrates a close-up front side perspective view of the floating power connector 100 of FIG. 1A, focusing on the depressible tab 114. As illustrated, when not pressed, the protruding portion 116 of the depressible tab 114 may extend out-of-plane (in the z-direction) from the mounting surface in the z-direction. The degree to which the protruding portion 116 extends from the mounting surface is sufficient to abut an edge of a panel opening into which the floating power connector is to be inserted, thereby functioning as described above to prevent the floating power connector from returning to its insertion position after it has been inserted into the panel. However, the depressible tab 114 may be pressed to move into the recess 122 in the flange 105, such that the protruding portion 116 is either flush with or recessed from the mounting surface 106 and thereby does not prevent sliding of the floating power conductor to its insertion position with respect to a panel. An example of such operation is illustrated in FIGS. 2A-2D and described further below.

FIG. 1E illustrates a close-up front view of the depressible tab 114. The figure highlights the opening 120 in which the tab sits, and further highlights that the depressible tab 114 is attached to the mounting surface 106 at a fixed end 115 and includes a free end 117 opposite the fixed end 115.

FIG. 1F illustrates a close-up side view of the depressible tab 114. The figure highlights that in the illustrated non-limiting embodiment the protrusion 116 on the depressible tab 114 has two widths. The figure also highlights the depth D1 of the recess 122 that the depressible tab 114 depresses into.

FIGS. 2A-2D show a sequence of steps to lock the floating power connector of FIGS. 1A-1F in an opening of a mounting component, such as a panel. This sequence includes an alignment step, an insertion step and a sliding step which locks the floating power connector in the opening. In the example of FIGS. 2A-2D, the floating power connector includes lugs 121 (as part of the terminals of the floating power connector) to which cables 123 are attached.

FIGS. 2A-2B illustrate an alignment step, with FIG. 2A providing an upper rear perspective view and FIG. 2B providing a lower rear perspective view. In the alignment step, the floating power connector 100 and a panel 130 (which is an example of a mounting component) may be aligned such that the floating power connector 100 is in an insertion position. In this example, when in the insertion position, the retention feature 108 and retention feature 118 align with notches 125 and 127 in the panel. In the state illustrated in FIGS. 2A-2B, the retention features 108 and 118 are aligned with notches 125 and 127, respectively, so that the portions of the floating power connector forward of flange 105 can be inserted into the opening in the panel 130. The depressible tab 114 is positioned such that when the floating power connector 100 is in the insertion position, the depressible tab 114 is facing the backside of the panel 130.

In an insertion step, the floating power connector 100 may be pressed in the direction of the arrows in FIGS. 2A-2B, which in some embodiments may be the z-direction. Pressing the floating power connector 100 in the direction of the arrows causes the depressible tab 114 to press against the backside of the panel 130 and to deflect in the direction opposite that in which the floating power connector 100 is pressed. The retention features 108 and 118 may pass through notches 125 and 127.

FIG. 2C is a side view of the floating power connector 100 and panel 130 when the floating power connector 100 is aligned with the panel 130 and pressed into the panel 130. In this image, the floating power connector 100 is pressed in the z-direction and the depressible tab 114 deflects in the negative z-direction. As can be seen in FIG. 2C, the depressible tab 114 deflects into the recess 122. For example, the free end 117 deflects into the recess 122 such that the protruding portion 116 may be flush with or recessed from the backside of the panel 130. The protruding portion 116 may be flush with or recessed from the mounting surface 106 of the floating power connector 100.

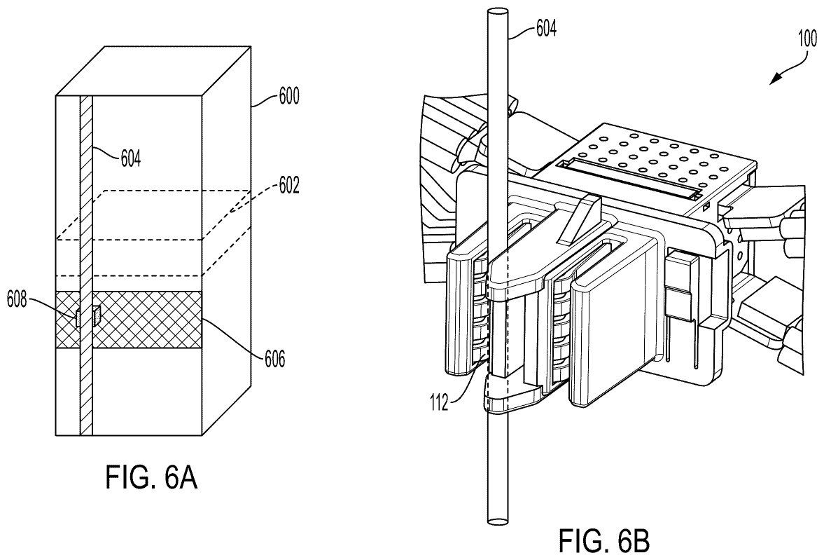

FIG. 2D illustrates the sliding step of the floating power connector insertion process, resulting in the floating power connector 100 being locked in the opening in the panel 130. The floating power connector 100 is slid in a direction in-plane with the mounting surface 106 and panel 130. In the illustrated non-limiting example, the floating power connector 100 is slid in the x-direction until the depressible tab 114 is no longer against the backside of the panel 130. At this point, the depressible tab 114 is no longer deflected into the recess 122, but instead returns to its undeflected or unbiased state, and the protruding portion 116 comes out-of-plane from the mounting surface 106 and the panel 130. In this state, the depressible tab 114 restricts motion of the floating power connector 100 in the transverse (e.g., horizontal) direction (e.g., x-direction) relative to the panel 130 back towards the insertion position, thus locking the floating power connector 100 into the opening in panel 130. The floating power connector 100 may then be connected to a power source, such as a busbar, by coupling the plurality of electrical contacts 112 to the power source, an example of which coupling is shown in FIGS. 6A-6B and described further below.

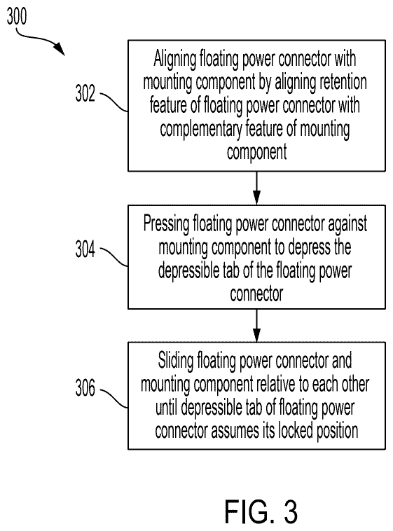

FIG. 3 is a flowchart of a process 300 for inserting a floating power connector into a mounting component (e.g., a panel) according to an embodiment. The sequence of steps described in connection with FIGS. 2A-2D is an example of the process 300.

The process 300 begins at step 302 with aligning the floating power connector with the mounting component by aligning a retention feature of the floating power connector with a complementary feature of the mounting component. Examples of the retention features and complementary features have been described in connection with FIGS. 2A-2D, such as the retention features 108 and 118 and the notches 125 and 127. The mounting component may be a panel, or any other suitable mounting component. The floating power connector may include a depressible tab of the types described herein, and the result of step 302 may be that depressible tab faces a backside of the mounting component.

The process 300 proceeds to step 304 which involves pressing the floating power connector (e.g., floating power connector 100) against the mounting component (e.g., panel 130) to depress the depressible tab of the floating power connector into a recess. FIG. 2C illustrates an example of this step. The result of this step, as illustrated in the example of FIG. 2C, is that the depressible tab may contact the backside of the mounting component and be deflected into a recess such that it is flush with or recessed from a mounting surface of the floating power connector.

The process 300 proceeds to step 306 which involves sliding the floating power connector and the mounting component relative to each other in a direction in-plane with the mounting component until the depressible tab of the floating power connector assumes its locked position. As shown in the example of FIG. 2D, the locked position of the depressible tab may involve the depressible tab moving out of a recess in the floating power connector so that a protruding portion of the depressible tab protrudes out-of-plane from the mounting component and abuts an edge of an opening in the mounting component.

FIGS. 4A-4C show a sequence of steps to remove the floating power connector 100 from its mounted position in a panel 130. This sequence includes a pressing step, a sliding step, and a removal step.

The removal process begins as shown in FIG. 4A, by pressing the depressible tab 114 into the recess of the floating power connector 100 until the protruding portion 116 of the depressible tab is flush with or recessed from the plane of the mounting surface 106 (FIG. 1A). This act may be performed by a user 400. Pressing the depressible tab in this manner frees the floating power connector 100 to move relative to the panel, for example in a horizontal direction, back towards the insertion position in which the retention features of the floating power connector 100 align with complementary features (e.g., notches) of the panel.

FIG. 4B illustrates the sliding step of the floating power connector removal process. In the sliding step, the floating power connector 100 is slid in-plane with the mounting surface 106 and panel 130 into the insertion position where retention features 108 and 118 align with notches 125 and 127. Examples of the retention features have been described above in connection with FIGS. 2A-2B. It should be appreciated from that description and from FIGS. 4A-4C that the retention features may be slidable retention features in at least some embodiments. In the example of FIG. 4B, the floating power connector 100 is slid in the x-direction. At this stage of the process, the depressible tab 114 is no longer visible from the front of the floating power connector 100 because it is obscured by the mounting component, in the manner shown in FIG. 2C and described previously.

FIG. 4C illustrates the removal step of the floating power connector removal process. Once the retention features of the floating power connector 100 and the complementary features of the panel 130 are aligned, the floating power connector 100 is pulled out of the opening in the panel. In the illustrated example, that involves pulling the floating power connector 100 in the negative z-direction until the floating power connector 100 is no longer in the panel 130.

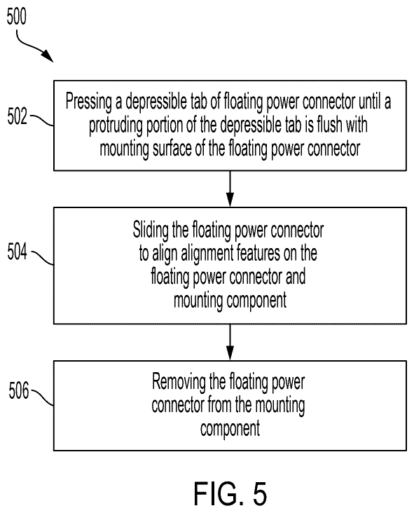

FIG. 5 is a flowchart of a process for removing a floating power connector from a mounting component according to a non-limiting embodiment. The steps described in connection with FIGS. 4A-4C are an example of the process of FIG. 5.

The floating power connector removal process 500 begins at step 502 with pressing a depressible tab of the floating power connector until a protruding portion of the depressible tab is flush with or recessed from a mounting surface of the floating power connector. FIG. 4A illustrates an example of this step. A user may perform step 502 by pressing the depressible tab.

The floating connector removal process 500 proceeds to step 504 which involves sliding the floating power connector in-plane with the mounting surface of the floating power connector until retention features on the floating power connector and complementary features on the mounting component are aligned. FIG. 4B illustrates an example of this step. Examples of retention features have been described previously herein, for example in connection with FIGS. 2A-2B.

The floating connector removal process 500 proceeds to step 506 which involves removing the floating power connector 100 from the mounting component. This may be done by pulling the floating power connector out-of-plane from the mounting component. For example, the floating power connector may be pulled back from an opening in the mounting component. FIG. 4C illustrates an example of this step.

Power connectors of the types described herein may be coupled to various power sources and to various electronic components. FIGS. 6A-6B illustrate a non-limiting example of components to which the power connectors may be connected.

In FIGS. 6A and 6B, the floating power connector is coupled to a busbar. Busbars represent one example of a power source to which such floating power connectors may be coupled. The system comprises a rack 600 holding rack-mounted electronics 602, a vertical busbar 604, a panel 606, and a floating power connector 608.

The rack 600 may be any suitable rack for holding the rack-mounted electronics 604. Alternatively, a cabinet or other housing for holding electronics may be used.

The rack-mounted electronics 602 may be electronics that are to be powered by the power source represented by busbar 604. For example, the rack-mounted electronics 602 may be server equipment in a server facility. Other forms of electronics may be used in alternative embodiments.

The busbar 604 provides power for powering the rack-mounted electronics. Thus, the busbar may be configured to provide a suitable power level. In some embodiments the busbar may provide tens of Amps of current, hundreds of Amps, or thousands of Amps. Although a single busbar is shown, multiple busbars may be provided to provide for a complete circuit, including a return path, or to accommodate different levels and types of power. The busbar may be formed of any suitable material.

Although busbars represent one example of a power source to which floating power connectors of the types described herein may be coupled, power connectors having a depressible tab to provide a snap-to-lock function as described herein are not limited to use with just busbars. Rather, power connectors of the types described herein may be coupled to various types of power sources.

The panel 606 and floating power connector 608 may be the types described in connection with FIGS. 2A-2D, as non-limiting examples. Panel 606, may be a panel of an enclosure of an electronic device, such as a server or a switch, that draws power from busbar 604, for example. In some embodiments, the floating power connector 608 is the same type of floating power connector as connector 100, and is configured to couple to the busbar 604 by the plurality of electrical contacts 112. FIG. 6B illustrates such a connection, with the busbar 604 inserted between the plurality of electrical contacts 112. In this example, the force to bring floating power connector 100 and busbar 604 together may be generated by inserting the electronic device into the rack.

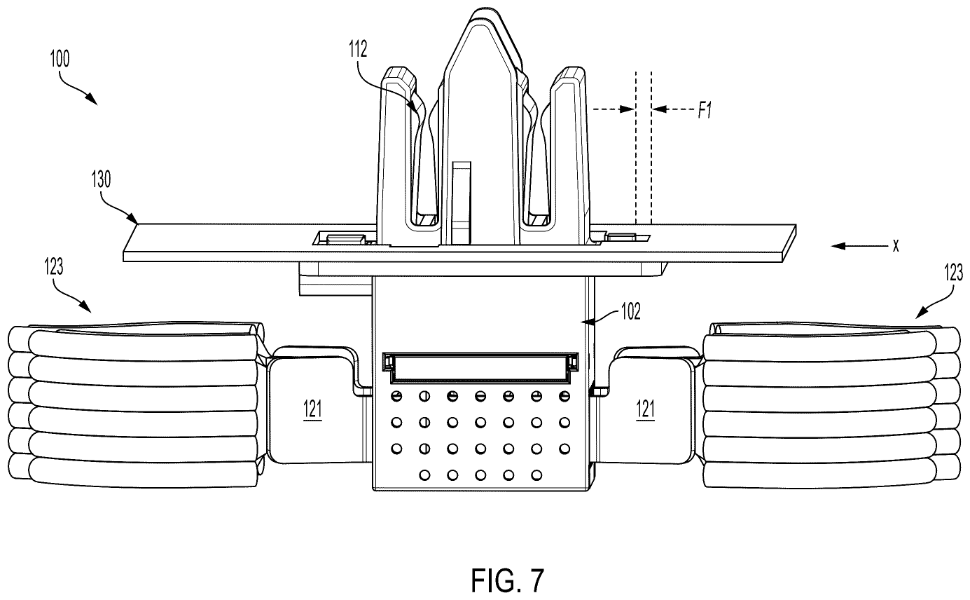

FIG. 7 illustrates a top view of the complete floating power connector with cables and shows the amount of float provided. The numbered components have been described earlier with respect to previous figure and are not described in detail again here. However, FIG. 7 shows the degree of float F1 provided in the x-direction in this example. As described previously herein, although the floating power connector may be locked within an opening of the panel 130, it may be free to float within the opening by a suitable amount to accommodate misalignment with a busbar or other power source.

Aspects of the present technology may provide various benefits. Some such benefits have been described, and some are described further now. Not all embodiments provide all benefits and benefits other than those described herein may be realized by some embodiments.

Aspects of the present technology provide for simple locking and removal of a power connector from a mounting component, such as a panel. The provision of a depressible tab allows for simple snap-to-lock functionality, whereby the depressible tab is pressed into a recess and then snaps into a locking position when the power connector is appropriately positioned. Removal may be simple as well, involving the pressing of a depressible tab from an easily accessible front side of the power connector. The provision of a depressible tab on a front face of the power connector may reduce or avoid the need to access the power connector from a back side to perform removal. Also, the provision of a depressible tab on the front face may leave or create additional room on the backside of the power connector for cable connections, free from interference of the locking mechanism.

Further, aspects of the present technology provide for high power connections to be formed in an electronic system. While described in terms of making connections to draw power from a busbar, the designs herein can be used to make connections to source power onto a busbar. The cables extending from connector 100, for example, may be connected to a power supply or line voltage such that power flows through connector 100 to a mated busbar.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A floating power connector for connecting a power source to a plurality of cables, the floating power connector comprising:
a housing having a mounting surface with a recess;
a mating interface protruding from the mounting surface and having a plurality of electrical contacts configured to couple to the power source; and
a depressible tab coupled with the housing of the floating power connector and having a protruding portion that protrudes beyond the mounting surface when unbiased and that sits flush with or is recessed from the mounting surface when pressed into the recess in the mounting surface.

2. The floating power connector of claim 1, wherein the depressible tab is integrally molded with the housing.

3. The floating power connector of claim 1, wherein the protruding portion of the depressible tab comprises multiple segments of different widths.

4. The floating power connector of claim 1, wherein the depressible tab has a first end that is fixed relative to the housing and a second end that is movable into the recess.

5. The floating power connector of claim 4, wherein the second end of the depressible tab is a free end.

6. The floating power connector of claim 1, the housing further comprises a retention feature having an opposing surface opposite the mounting surface and configured to couple to a mounting component.

7. The floating power connector of claim 6, wherein the retention feature is a slidable retention feature.

8. The floating power connector of claim 1, further comprising a retention feature configured to pass through a complementary feature in a panel.

9. The floating power connector claim 1, further comprising a terminal terminating on one end with the plurality of electrical contacts and on another end with a lug.

10. The floating power connector of claim 9, wherein the lug is configured to couple to a plurality of cables.

11. A floating power connector configured to connect to a power source, the floating power connector comprising:
a housing;
a self-alignment mechanism configured to align the floating power connector with the power source;
one or more terminals configured to couple to a cable; and
a depressible tab configured to mechanically restrict the floating power connector from moving into an insertion position within an opening in a panel.

12. The floating power connector of claim 11, wherein the depressible tab is configured to move into a recess when pressed.

13. The floating power connector of claim 12, wherein the depressible tab has a fixed end and a free end.

14. The floating power connector of claim 11, wherein the self-alignment mechanism comprises a plurality of spring fingers configured to fit around the power source.

15. The floating power connector of claim 11, wherein the power source comprises a busbar, and wherein the self-alignment mechanism is configured to couple to the busbar.

16. A method of removing a floating power connector from an opening in a panel in which the floating power connector is disposed, the method comprising:
pressing a depressible tab of the floating power connector until a protruding portion of the depressible tab is flush with or recessed from a mounting surface of the floating power connector;
sliding the floating power connector parallel to a plane of the mounting surface to a position in which a retention feature of the floating power connector is aligned with a complementary feature of the panel; and
while the retention feature of the floating power connector is aligned with the complementary feature of the panel, moving the floating power connector in a direction substantially perpendicular to the plane of the mounting surface.

17. The method of claim 16, further comprising releasing the depressible tab after initiating the sliding of the floating power connector parallel to the plane of the mounting surface.

18. The method of claim 16, wherein the complementary feature of the panel is a notch in the panel.

19. A method of inserting a floating power connector into an opening in a panel to which the floating power connector is to be mounted, the method comprising:
aligning a retention feature of the floating power connector with a complementary feature of the panel;
pressing the floating power connector against a first side of the panel to depress a depressible tab of the floating power connector into a recess in the floating power connector; and
sliding the floating power connector in a direction parallel to the first side of the panel until the depressible tab returns to an unbiased state out of the recess in the floating power connector.

20. The method of claim 19, wherein sliding the floating power connector in the direction parallel to the first side of the panel comprises sliding the floating power connector so that the retention feature of the floating power connector is positioned on a second side of the panel.
